(19) United States
(12) Patent Application Publication
(10) Pub. No.: US 2023/0281296 A1
(43) Pub. Date: Sep. 7, 2023

(54) LOCATION-BASED PATTERN DETECTION FOR PASSWORD STRENGTH

(71) Applicant: ServiceNow, Inc., Santa Clara, CA (US)

(72) Inventor: Mohamed Sofiane Talmat, Utrecht (NL)

(21) Appl. No.: 17/688,529

(22) Filed: Mar. 7, 2022

(51) Int. Cl. G06F 21/46

(52) U.S. Cl. CPC G06F 21/46

(57) ABSTRACT

A password is received for evaluation. For each of at least a portion of characters included in the password, a corresponding location coordinate of a corresponding physical key location on a physical input device key layout is determined. Using the determined location coordinates, an ordered series of data representing the password is generated. One or more processors are used to determine a strength of the password including by utilizing the generated ordered series of data to perform an analysis based on location pattern detection.

### BACKGROUND OF THE INVENTION

Passwords are a shared secret that allow a system such as a website or an application service to confirm the identify of a user. A common approach for many password-protected systems is to allow the user to select their own password. Depending on the system, different password creation rules may apply. For example, password creation rules can include requiring that a user's password contains a minimum number of characters and includes a minimum variety of characters such as a minimum combination of symbols, numbers, and mixed upper- and lower-case letters. These rules are typically enforced to help prevent the user from selecting a weak password. Weak passwords can include passwords that are easily guessed, are known to be compromised, and/or are easy to predict. In many scenarios, the password requirements implemented by a system and what passwords are considered weak are based on the expected security threat the system faces.

### BRIEF DESCRIPTION OF THE DRAWINGS

Various embodiments of the invention are disclosed in the following detailed description and the accompanying drawings.

FIG. 1 is a flow chart illustrating an embodiment of a process for detecting password strength using a location pattern analysis.

FIG. 2 is a flow chart illustrating an embodiment of a process for assigning coordinate systems to a key input device.

FIG. 3 is a diagram illustrating an example input device key layout with an assigned two-dimensional coordinate system.

FIG. 4 is a flow chart illustrating an embodiment of a process for detecting password strength using an assigned key layout.

FIG. 5 is a flow chart illustrating an embodiment of a process for analyzing password strength using a trained machine learning model.

FIG. 6 is a diagram illustrating a graph of an ordered series generated for an example password using location coordinates.

FIG. 7 is a flow chart illustrating an embodiment of a process for analyzing password strength for input key patterns.

FIG. 8 is a diagram illustrating a graph of an ordered series of character distances generated for an example password using location coordinates.

FIG. 9A is a diagram illustrating a graph of an ordered series generated for an example password using location coordinates.

FIG. 9B is a diagram illustrating a graph of an ordered series of character distances generated for an example password using location coordinates.

FIG. 10A is a diagram illustrating a graph of an ordered series generated for an example password using location coordinates.

FIG. 10B is a diagram illustrating a graph of an ordered series of character distances generated for an example password using location coordinates.

FIG. 11 is a functional diagram illustrating a programmed computer system for detecting password strength using a location pattern analysis.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining password strength using location pattern analysis is disclosed. Using the disclosed techniques, the characters of a password are mapped to location coordinates based on the physical locations of the input keys associated with each password character. For example, a physical or virtual input keyboard can be mapped to a two-dimensional coordinate system, where each keyboard input key is associated with a different two-dimensional location coordinate. The different characters of the password are then assigned location coordinates based on the location coordinates of their corresponding input keys of the input keyboard.

In various embodiments, an ordered series based on the password character location coordinates is generated. The generated location-based ordered series is then analyzed to determine the strength of the password. For example, the ordered series is analyzed to identify patterns associated with weak passwords. In various embodiments, different forms of ordered series are applicable and can be used to detect different types of weak passwords. For example, an ordered series of two-dimensional location coordinates, one for each character of the password, is generated to match existing weak or compromised passwords. As another example, an ordered series of character distances is generated, where the ordered character distances are the distances between each two neighboring characters of the password. The ordered series of character distances can be used to detect weak passwords generated by following a pattern based on the location of keyboard keys, such as a zigzag or another pattern based on key location.

In some embodiments, a password is received for evaluation. For example, a user enters a new password as part of a password creation process associated with the user's account. The password is analyzed to determine whether the password is sufficiently strong and meets the strength requirements to be accepted as the user's new password. For example, in the event the system detects that a weak password has been entered by the user, the system can reject the weak password and require the user to provide a different password that meets minimum password strength requirements. In some embodiments, for each of at least a portion of characters included in the password, a corresponding location coordinate of a corresponding physical key location on a physical input device key layout is determined. For example, each keyboard key on a physical keyboard (such as the user's keyboard) is mapped to a location coordinate, such as a two-dimensional location having an X coordinate and a Y coordinate pair. Depending on the particular keyboard layout, different layouts and coordinate systems are appropriate. For example, in some embodiments, a particular QWERTY keyboard is mapped to a layout where the X-axis spans from 10 to 100, the Y-axis spans from 10 to 40, and each character is separated by 10 units. For the example layout, the upper-left number character “1” can correspond to the coordinates (10, 10) and the lower-right symbol character “/” can correspond to the coordinates (100, 40). As additional examples, the letter “A” can have the coordinates (10, 30) and the number “9” can have the coordinates (90, 10). The location coordinates of at least a portion of the characters of the password are determined. For example, for each character of the password, the corresponding two-dimensional location coordinate of the character is determined. Using the determined location coordinates, an ordered series of data representing the password is generated. For example, the ordered series can include the X and Y coordinates of each character of the password arranged in the order of the characters in the password. As another example, the ordered series can include an ordered series of the distances between characters of the password. Each distance in the ordered series is the distance between two characters in the password, starting with the first two characters of the password, then progressing to the second and third characters of the password, and finishing off with the last two characters of the password.

In some embodiments, one or more processors are used to determine a strength of the password including by utilizing the generated ordered series of data to perform an analysis based on location pattern detection. For example, the ordered series generated from the password and the location coordinates of the characters is analyzed to detect patterns. In various embodiments, different pattern analysis approaches can be utilized. For example, the analysis can be configured to identify passwords matching patterns associated with existing or known weak/compromised passwords. As another example, the analysis can be performed to identify passwords that rely on following a repeated pattern based on the location of the password character keys on the keyboard (such as a zigzag or another pattern based on key location). In some embodiments, in the event a pattern is detected, the received password is determined to be a weak password and in the event no pattern is detected, the received password is determined to be a strong password. In some embodiments, the result of the pattern analysis is a strength score. For example, a strength score can range from a low score for a weak password to a high score for a strong password.

Although disclosed techniques are at times described herein with respect to a physical input device, such as a physical or hardware keyboard, for entering password characters, the disclosed techniques also apply to a variety of different keyboards and other key input devices. For example, the disclosed techniques apply to virtual and/or software keyboards. In various embodiments, virtual and/or software keyboards, such as a virtual/software keyboard rendered on a touch screen, projected on a typing surface, or projected in a virtual/augmented reality display, can include physical properties including corresponding physical locations for keys. Although virtual and implemented at least in part in software, the different key input devices require physical interaction and corresponding physical key locations. For example, a virtual/augmented reality display can display a virtual keyboard that a user physically interacts with by, for example, using a pointing device, using eye movements, or another physical interaction. In some embodiments, the disclosed techniques are implemented to analyze passwords entered using a software keyboard implemented on a mobile device using a touch screen. Similarly, the disclosed techniques can be implemented to analyze passwords entered using a software/virtual keyboard implemented on a virtual or augmented reality system. In various embodiments, the disclosed techniques also apply to password input devices for entering keys of a password other than a traditional keyboard. For example, different password input devices are supported by mapping the particular key input device to one or more coordinate systems, such as one or more two-dimensional and/or three-dimensional coordinate systems. In various embodiments, the input device can include multiple different components including separated or split components, for example, for the right hand, left hand, and eyes. Each component can be mapped to a different coordinate system and/or a coordinate system that spans one or more components.

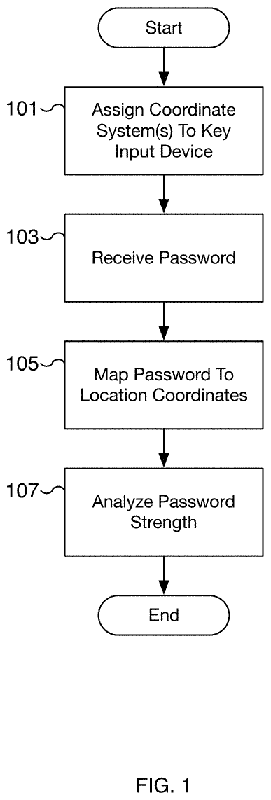

FIG. 1 is a flow chart illustrating an embodiment of a process for detecting password strength using a location pattern analysis. For example, the process of FIG. 1 can be used to evaluate whether a new password meets a minimum password strength. In the event the password does not meet the required password strength, the user or operator can be asked to provide a stronger password. By utilizing the process of FIG. 1, a password-protected system can significantly decrease the threat posed by weak passwords. In various embodiments, the process of FIG. 1 evaluates a password for location-based patterns that indicate a weak password. For example, a password is converted into an ordered series using the location coordinates of the key input device used to enter the password. In some embodiments, the key input device is a keyboard such as a physical keyboard or a virtual/software keyboard.

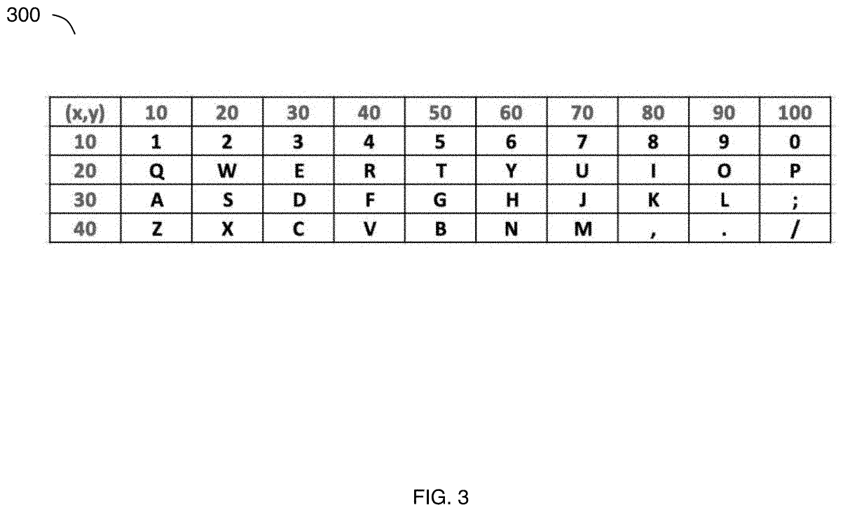

At 101, one or more coordinate systems are assigned to the key input device. For example, a layout is created of the keys of the input device, such as a layout of the keys for the type of keyboard used to enter passwords. The key layout is assigned to a coordinate system, such as a two-dimensional coordinate system with an X-axis and a Y-axis. For example, a traditional QWERTY keyboard can be mapped to a two-dimensional rectangular key layout, where the X-axis spans from 10 to 100, the Y-axis spans from 10 to 40, and each character is separated by 10 units, as shown in FIG. 3. In various embodiments, keys that are not used in passwords and/or are associated with invalid password characters, such as the shift, tab, caps lock, function, return, space, cursor, and delete keys, among others, may not be included in and can be removed from the layout, particularly if they reside on the periphery of the input device. For the example layout, the upper-left number character “1” corresponds to the coordinates (10, 10) and the lower-right symbol character “/” corresponds to the coordinates (100, 40). As additional examples, the letter “A” has the coordinates (10, 30) and the number “9” has the coordinates (90, 10). In this example, each key has the same width, however, in alternative embodiments, the location coordinates of the keys can be adjusted for the size of the keyboard keys.

In some embodiments, the input device may require multiple coordinate systems. For example, an input device may include two or more separate input components, such as one for the left hand, one for the right hand, and one for the eyes. The different components can be mapped to layouts that exist in different coordinate systems. For example, the layout for a virtual reality headset and controllers may have a different coordinate system for the left-hand controller input device, the right-hand controller input device, and a head mounted display with eye tracking. In some embodiments, the different components can be mapped onto the same coordinate system. For example, a split keyboard with a left-hand component and a right-hand component can be mapped to the same coordinate system but may require a gap between the left-hand and right-hand keys that would not exist for a traditional non-split keyboard.

At 103, a password is received. For example, the received password is inputted by a user or operator using an input device with the same or similar layout to the key input device of step 101. In various embodiments, the password received is received as a sequence of input keys. Depending on the system, the keys can be a combination of allowable characters that includes letters, numbers, symbols, and/or other allowable characters. In some embodiments, the input device is not a keyboard and the inputted keys for the password can include input keys specific to the input device and system. For example, a password inputted by an input controller such as a virtual reality controller can include keys such as button presses and directional input. In various embodiments, the input device is not physically attached to the password-protected system such as a cloud-based application service. For example, the key input device can be the key input device of a client, such as a network client, that interfaces with the password-protected cloud-based application service.

At 105, the password is mapped to location coordinates. For example, using the coordinate system(s) assigned to the input device at 101, the password received at 103 is mapped to location coordinates. In some embodiments, for each character of the password, a location coordinate is determined. The determined location coordinate for a character corresponds to the location coordinate assigned to the corresponding input key of the key input device. In various embodiments, the location coordinates are two-dimensional and/or three-dimensional coordinates. For example, for a physical hardware keyboard, the location coordinate of a character of a password corresponds to the two-dimensional location coordinate assigned to the physical key location on a physical input device layout for that character. Using the example QWERTY keyboard from step 101, the letter “A” is mapped to the coordinates (10, 30), the number “1” to the coordinates (10, 10), and the number “9” to the coordinates (90, 10). Accordingly, an example password “A19” is mapped to the ordered series of (X, Y) coordinates [(10, 30), (10, 10), (90, 10)].

At 107, the password strength is analyzed. For example, using the location coordinates determined for the password at 105, the password strength of the received password is analyzed. In some embodiments, the analysis results in a password strength score. For example, a low strength score corresponds to a weak password and a high strength score corresponds to a strong password. A password-protected system can implement one or more thresholds associated with a password strength score to determine whether a password meets the system requirements for minimum password strength. In various embodiments, the password strength is determined by analyzing data for patterns associated with password location coordinates. For example, the analysis can detect patterns associated with weak passwords to determine a password strength. Passwords that match patterns associated with weak passwords have a lower password strength whereas passwords that do not match patterns associated with weak passwords have a stronger password strength. In various embodiments, the analysis is performed on the ordered series of coordinates determined at 105. In some embodiments, the location coordinates of the password determined at 105 are further processed, for example, to generate another ordered series also associated with the password that is used for password strength analysis.

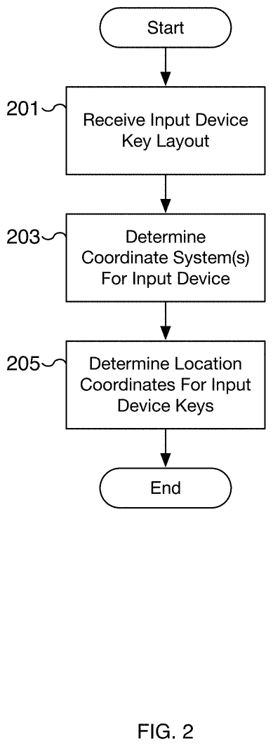

FIG. 2 is a flow chart illustrating an embodiment of a process for assigning coordinate systems to a key input device. For example, using the process of FIG. 2, an input device such as a keyboard is assigned one or more coordinate systems. The assigned coordinate system(s) can be utilized to map each character of a password to a corresponding location coordinate assigned to the corresponding physical key of the character on the input device. When the mapped location coordinates of the characters of a password are compared, the mapped location coordinates correspond to the relative physical key locations of the corresponding physical keys. For example, characters with physical keys that are nearby on the input device have mapped location coordinates that are also nearly in the assigned coordinate system. In various embodiments, the assigned coordinate system can be a one-dimensional coordinate system or a multi-dimensional coordinate system. For example, depending on the input device, the assigned coordinate system can be a two-dimensional, three-dimensional, or another n-dimensional coordinate system. In some embodiments, multiple coordinate systems are assigned, for example, in the event different components of the input device exist in different relative coordinate systems. In some embodiments, the process of FIG. 2 is performed at 101 of FIG. 1.

At 201, an input device key layout is received. For example, an operator or user can specify the layout of the input device used for entering passwords. In some embodiments, the layout of the input device is specified by configuring the client and/or service application software. For example, a set list of clients may be supported by the application service and the layout of those supported client devices is used. In various embodiments, the type of input device may be manually and/or automatically detected, and the input device key layout can be automatically retrieved from a database of input device key layouts based on the detected input device type. In some embodiments, the input device key layout specifies the keys and their relative positions from one another.

At 203, one or more coordinate systems are determined for the input device. In various embodiments, the input device is assigned to one or more coordinate systems based on the device's layout. For example, a traditional keyword with keys arranged in a two-dimensional grid can be assigned to a two-dimensional coordinate system with an X-axis and a Y-axis. In one embodiment, as discussed previously and shown in FIG. 3, a traditional QWERTY keyboard can be assigned to a two-dimensional coordinate system, where the X-axis spans from 10 to 100, the Y-axis spans from 10 to 40, and each character is separated by 10 units. In various embodiments, keys associated with invalid password characters such as the shift, tab, caps lock, function, return, space, cursor, and delete keys, among others, may not be included in (and may be removed from) the layout, particularly if they reside on the periphery of the input device.

In some embodiments, a similar keyboard or another input device can be determined to map to a three (or more) dimensions with an X-axis, a Y-axis, a Z-axis, and additional axes if necessary. For example, in some embodiments, the shift key of a keyboard is used to differentiate between upper- and lower-case letters and the shift key maps a third (Z-axis) dimension to the keyboard. Additional modifier keys could, for example, map a key when pressed in combination with the modifier key to a different dimension. In some embodiments, the multiple dimensions simulated by modifier keys are ignored. For example, a shift key that simulates a Z-axis to differentiate between uppercase and lowercase characters can be ignored and an input key with multiple values (such as “1” and “!”, “2” and “@”, and “a” and “A”) has only a single Z-coordinate value. Instead of a three-dimensional (X, Y, Z) location coordinate that accounts for a modifier key such as the shift key pressed in combination with another input key, a two-dimensional (X, Y) location coordinate is assigned to the key or key combination. In this example, upper- and lower-case characters (e.g., “A” and “a”) can map to the same (X, Y) location coordinate. Similarly, different characters such as some symbols and numbers (e.g., “1” and “!” and “2” and “@”) can map to the same (X, Y) location coordinate.

In some embodiments, the input device may have multiple components and be assigned to one or multiple coordinate systems. For example, the input device for a virtual reality system may include three components: a headset and two hand controllers, one for each hand. Each component may be determined to have a different coordinate system such as one for the left-hand controller input device, one for the right-hand controller input device, and one for a head mounted display with eye tracking. Although from a hardware perspective the input devices may be considered as three separate devices, for the purposes of entering a password, the three different input devices are treated as a single key input device with multiple components. In some embodiments, an input device with multiple components can be mapped onto the same coordinate system. For example, a split keyboard with a left-hand component and a right-hand component can be determined to use the same coordinate system but may require a gap between the left-hand and right-hand keys that would not exist for a traditional non-split keyboard.

At 205, the location coordinates for input device keys are determined. Using the coordinate system(s) determined at 203, a determination is made that the keys of the input device corresponding to the allowable password characters are assigned to specific location coordinates. For each character and key, the relative assigned location coordinates further correspond to the relative physical key locations. For example, with respect to the QWERTY keyboard used as an example in step 203 and shown in FIG. 3 (where the X-axis spans from 10 to 100, the Y-axis spans from 10 to 40, and each character is separated by 10 units), the upper-left number character “1” maps to the coordinates (10, 10) and the lower-right symbol character “/” maps to the coordinates (100, 40). As additional examples, the letter “A” maps to the coordinates (10, 30), the letter “S” to the coordinates (20, 30), and the letter “D” to the coordinates (30, 30). Similarly, the number “1” maps to the coordinates (10, 10), the number “2” to the coordinates (20, 10), and the number “3” to the coordinates (30, 10). In this example, each key has the same width, however, in alternative embodiments, the location coordinates of the keys can be adjusted for the size of the keyboard keys.

FIG. 3 is a diagram illustrating an example input device key layout with an assigned two-dimensional coordinate system. In the example shown, input device key layout 300 is an approximation of the actual key layout of the key input device. The locations of the keys in input device key layout 300 resemble their relative locations on the key input device. For example, keys on the key input device that are near one another are similarly near one another on input device key layout 300. In the example shown, input device key layout 300 is assigned a two-dimensional coordinate system with an X-axis and a Y-axis. The X-axis spans from 10 to 100, the Y-axis spans from 10 to 40, and each character of the QWERTY keyboard is separated by 10 units. Keys that are not used in entering passwords (e.g., the shift, tab, caps lock, function, return, space, cursor, and delete keys, among others), that reside on the periphery of the key input device, and that do not impact the relative locations of the keys that are used in valid passwords, are not included as part of input device key layout 300. For input device key layout 300, the upper-left number character “1” corresponds to the coordinates (10, 10) and the lower-right symbol character “/” corresponds to the coordinates (100, 40). As additional examples, the letter “A” has the coordinates (10, 30), the letter “S” has the coordinates (20, 30), and the letter “D” has the coordinates (30, 30). Similarly, the number “1” has the coordinates (10, 10), the number “2” has the coordinates (20, 10), and the number “3” has the coordinates (30, 10). Using input device key layout 300, keys used on the key input device to enter a password can be mapped to location coordinates. For example, the password “TEST123” is mapped to the ordered series of (X, Y) coordinates [(50, 20), (30, 20), (20, 30), (50, 20), (10, 10), (20, 10), (30, 10)].

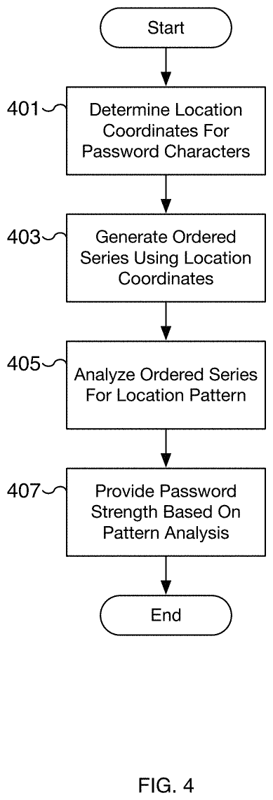

FIG. 4 is a flow chart illustrating an embodiment of a process for detecting password strength using an assigned key layout. In various embodiments, the process of FIG. 4 evaluates a password for location-based patterns using location coordinates associated with the characters of a password from an assigned key layout. The assigned key layout allows a character to be mapped to a location coordinate, such as a two-dimensional (X,Y) location coordinate, that corresponds to the location of the input key on the key input device associated with the character. An ordered series of data is created using the location coordinates of the password characters. The ordered series of data is analyzed for patterns, such as patterns associated with weak passwords, to determine the strength of the password. In some embodiments, the process of FIG. 4 is performed at 103, 105, and/or 107 of FIG. 1. In some embodiments, the location coordinates for the password are determined by the key layout and associated coordinate system(s) assigned to map input keys and characters to location coordinates using the process of FIG. 2.

At 401, location coordinates for password characters are determined. For example, using an assigned key layout and associated coordinate system(s), each password character can be mapped to a location coordinate. In various embodiments, the mapped location coordinate for a character corresponds to the relative location of the input key on the key input device associated with the character. For example, using the input device key layout of FIG. 3 as the assigned key layout, each character of the password “TEST123” can be mapped to a location coordinate. The letter “T” maps to the coordinates (50, 20), the letter “E” to the coordinates (30, 20), the letter “S” to the coordinates (20, 30), the letter “T” to the coordinates (50, 20), the number “1” to the coordinates (10, 10), the number “2” to the coordinates (20, 10), and the number “3” to the coordinates (30, 10). In various embodiments, different assigned key layouts can result in different location coordinates for the same password.

At 403, an ordered series is generated using location coordinates. For example, the location coordinates for the password characters determined at 401 are arranged into an ordered series. In some embodiments, the order of the ordered series is based on the order that the characters appear in the password. For example, using the password “TEST123” and the corresponding location coordinates determined at 401, the ordered series of (X, Y) coordinates is [(50, 20), (30, 20), (20, 30), (50, 20), (10, 10), (20, 10), (30, 10)]. In some embodiments, a different ordered series based on location coordinates is generated. For example, different ordered series can be used to detect different types of weak passwords. In some embodiments, the generated ordered series is an ordered series of character distances, where the ordered character distances are the distances between each two neighboring characters of the password. For example, using the password “TEST123” and the corresponding location coordinates determined at 401, the ordered series of character distances is [(20.0), (14.1), (31.6), (41.2), (10.0), (10.0)]. In this example, the first data point (20.0) is the Euclidean distance between the location coordinates for the password characters “T” and “E,” the second data point (14.1) is the rounded Euclidean distance between the location coordinates for the password characters “E” and “S,” the third data point (31.6) is the rounded Euclidean distance between the location coordinates for the password characters “S” and “T,” the fourth data point (41.2) is the rounded Euclidean distance between the location coordinates for the password characters “T” and “1,” the fifth data point (10.0) is the Euclidean distance between the location coordinates for the password characters “1” and “2,” and the sixth and last data point (10.0) is the Euclidean distance between the location coordinates for the password characters “2” and “3.” In various embodiments, the ordered series of character distances can be used to detect weak passwords generated by following a pattern based on the location of the input keys, such as a zigzag or another pattern based on key location on a keyboard. Although the Euclidean distance can be used to determine data points for an ordered series, other measurement operations can be applied to generate a different type of ordered series to detect different types of weak passwords.

At 405, the ordered series is analyzed for a location pattern. For example, the ordered series generated at 403 is analyzed to detect for patterns based on the location coordinates of the password characters. The result of the pattern analysis is used to determine the password strength of the password. In various embodiments, the analysis performed is based on the type of the ordered series that is generated. Different types of ordered series can be generated to detect different types of location patterns. For example, the ordered series of location coordinates for password characters can be analyzed by matching the generated ordered series to patterns associated with weak or compromised passwords. The analysis for detecting patterns can be performed by applying pattern detection techniques, including image processing and/or statistical analysis techniques, to a graph of the generated ordered series. In some embodiments, the generated ordered series is compared to a set of ordered series generated using a reference dictionary of weak passwords. The reference dictionary can include, for example, English words, compromised passwords, commonly used passwords, previously used passwords, and other weak passwords. In some embodiments, the analysis utilizes a machine learning model trained using a data set of ordered series generated with the reference dictionary of weak passwords.

In some embodiments, the location pattern analysis is performed to detect for passwords that are inputted by following a pattern based on the location of input keys when entering the password on the key input device. For example, the location pattern analysis can detect a password where the user inputs the password characters by following a pattern, such as a zigzag pattern, on a keyboard. A zigzag pattern is just one example and many other patterns based on following an input key pattern exist and can be detected by the pattern analysis. Additional password patterns include using every third character in a keyboard row or using a pair of neighboring characters while simultaneously traversing the keyboard rows both up and down as well as from left to right. These types of passwords can appear to be random when viewed outside of the context of the key input device but follow a predictable pattern and only give the illusion of randomness. A system can be configured to treat these types of passwords as weak passwords.

In various embodiments, the analysis performed at 405 results in a password strength result. The result can be provided in different formats, such as a metric (e.g., a strength score), as a Boolean value corresponding to whether the password is strong or weak, or in another appropriate format. In some embodiments, the metric is a strength score, such as a value between 0.0 and 1.0, where a lower score corresponds to a weaker password and a higher score corresponds to a stronger password.

At 407, the password strength based on the pattern analysis is provided. For example, the analysis performed at 405 results in a password strength. In some embodiments, the password strength provided at 407 is provided as a strength score, such as a strength score between 0.0 and 1.0 (or another range). In some embodiments, the password strength provided at 407 is provided as a Boolean value corresponding to whether the password meets the strength requirements or as a password strength in another appropriate format. In various embodiments, based on the password strength provided at 407, the system can determine how to respond. For example, if the password strength corresponds to a weak password, the system may reject the password and require the user to provide a new password that meets the strength requirements.

In some embodiments, the password-protected system can be configured with one or more password strength thresholds. For example, the password strength determined at 405 must exceed a configured strength threshold for the corresponding password to meet the system password requirements. In some embodiments, different users or user groups can be configured with different strength thresholds. For example, a user belonging to a system administrator group may be required to meet a higher threshold than a user belonging to a temporary guest group. In various embodiments, the password strength is compared to the appropriate password threshold and can be used to provide a Boolean result for the password strength, such as whether the password meets the configured password strength and corresponding threshold requirements.

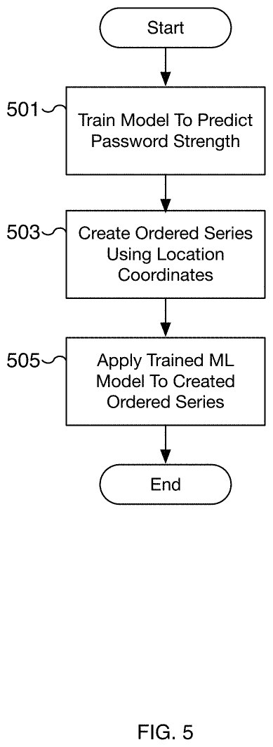

FIG. 5 is a flow chart illustrating an embodiment of a process for analyzing password strength using a trained machine learning model. In various embodiments, the process of FIG. 5 is used to compare a provided (or candidate) password to known weak and/or strong passwords. For example, the process can predict a password strength score for a provided password by using a trained machine learning model. In some embodiments, the step of 503 is performed at 105 of FIG. 1 and/or 403 of FIG. 4, and the step of 505 is performed at 107 of FIG. 1 and/or 405 of FIG. 4.

At 501, a machine learning model is trained to predict password strength. In some embodiments, the model is trained to classify a provided password by password strength. For example, the model can be trained with passwords that are labeled either strong (i.e., not weak) or weak. The training data set is created by applying the same techniques disclosed herein for generating an ordered series based on location coordinates but instead applied to the set of training passwords. For example, an ordered series is created for the training password as described with respect to step 503. The weak passwords can be sourced from a reference dictionary of weak passwords that includes trivial passwords, common or English dictionary words, compromised passwords, and/or previously used passwords, among other passwords deemed weak. The strong passwords can be generated, for example, by using a strong password generator. In various embodiments, the model is trained to classify a provided password as strong or weak.

In some embodiments, the model is trained to output a different password strength result. For example, the model can be trained to predict a strength metric, such as a strength score between 0.0 and 1.0, spanning a range of weak to strong passwords. In some embodiments, the model is trained to predict how closely a provided password matches an existing known weak password. Instead of requiring an exact string match, the trained model can output a password strength score (or a matching score) that corresponds to how closely the provided password matches a known weak password. This type of model has the advantage that a password is not required to be an exact match in order for the password to be classified as weak. For example, a password that is a close but not perfect match to a weak password can be treated as a weak password. As one example, the password “welcome” can be considered a weak password. Candidate passwords such as “welcome1,” “welcome,” “wellcome,” and “w3lcome,” among many other variations, are close but not exact matches but are still predicted to closely match the weak password “welcome.”

At 503, an ordered series is created using location coordinates. For example, using a provided (or candidate) password, location coordinates for each character of the password are determined in the order the characters appear in the password. In some embodiments, the location coordinates are determined using the layout and coordinate system assigned to the key input device. The input device key layout of FIG. 3 is one example of an assigned key layout that can be used to generate location coordinates for password characters. At 503, location coordinates are generated in the order that the characters appear in the password. For example, using the layout of FIG. 3, the ordered series of (X, Y) location coordinates for the password “TEST123” is [(50, 20), (30, 20), (20, 30), (50, 20), (10, 10), (20, 10), (30, 10)].

At 505, a trained machine learning model is applied to the created ordered series. For example, using for model trained at 501, a password strength is predicted for the ordered series created at 503. In various embodiments, the form of the predicted password strength result is dependent on the type of model used. For example, in some embodiments, the model can predict whether the password is strong (i.e., not weak) or weak. In some embodiments, the model predicts a strength metric, such as a strength score between 0.0 and 1.0, that corresponds to the relative strength of the password. In some embodiments, the model predicts how closely the provided password matches a known weak password. In various embodiments, the predicted password strength result can be further processed to perform additional analysis, such as comparing the password to configured password strength thresholds.

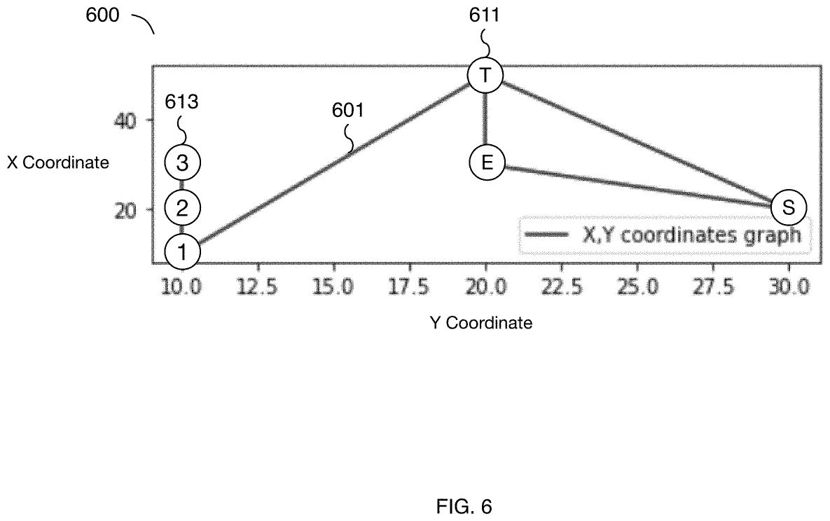

FIG. 6 is a diagram illustrating a graph of an ordered series generated for an example password using location coordinates. In the example shown, location pattern 600 corresponds to the password “TEST123” and the ordered series of (X, Y) coordinates [(50, 20), (30, 20), (20, 30), (50, 20), (10, 10), (20, 10), (30, 10)]. The ordered series of (X, Y) coordinates for “TEST123” is created using the input device key layout of FIG. 3. In some embodiments, the ordered series is generated at 105 of FIG. 1, 403 of FIG. 4, and/or 503 of FIG. 5. In the example shown, the X coordinate is shown on the vertical axis and the Y coordinate is shown on the horizontal axis. Location pattern 600 includes coordinates graph 601 with nodes corresponding to each character of the password. The node 611 for character “T” and node 613 for character “3” are labeled. The first node of coordinates graph 601 is node 611 (the letter “T”). Node 611 is followed by nodes “E,” S,” “T” (node 611), “1,” “2,” and “3” (node 613). Node 611 for the character “T” is repeated since the letter “T” appears twice in the example password “TEST123.” In various embodiments, the ordered series of coordinates graph 601 is applied at 505 of FIG. 5 to a trained machine learning model to determine the password strength for the associated password “TEST123.”

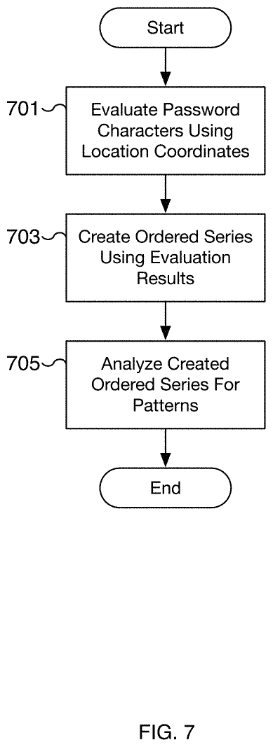

FIG. 7 is a flow chart illustrating an embodiment of a process for analyzing password strength for input key patterns. In various embodiments, the process of FIG. 7 is used to detect location patterns in a provided password by analyzing an ordered series of the password that is generated using location coordinates associated with the password. For example, an ordered series can be generated based on distances between characters of the password. The ordered series of character distances can be used to detect for weak passwords that are inputted to a system by following a pattern based on the location of keyboard keys, such as a zigzag or another pattern based on key location. Although the process of FIG. 7 is described with respect to an ordered series of character password distances, such as Euclidean distances, other comparison evaluations (e.g., other than or other forms of distance) can be implemented as well based on the location coordinates associated with the password characters. In some embodiments, the process of FIG. 7 is performed at 105 and/or 107 of FIG. 1 and/or at 403 and/or 405 of FIG. 4.

At 701, the password characters are evaluated using the location coordinates of the password characters. For example, the distances between each neighboring pair of characters can be measured and evaluated as a Euclidean distance. In some embodiments, other methods of evaluation are used, such as other methods of calculating distance or other comparison techniques. Using the Euclidean distance measures the relative travel distance from one character of the password to the next character with respect to the key input device. In various embodiments, the evaluation requires previously generating location coordinates for the password characters using a key layout and coordinate system such as the input device key layout of FIG. 3. For example, using the input device key layout of FIG. 3, the (X, Y) location coordinates for the password “TEST123” are (50, 20), (30, 20), (20, 30), (50, 20), (10, 10), (20, 10), and (30, 10). The corresponding evaluated Euclidean distances between the characters are 20.0 (between “T” and “E”), 14.1 (between “E” and “S”), 31.6 (between “S” and “T”), 41.2 (between “T” and “1”), 10.0 (between “1” and “2”), and 10.0 (between “2” and 3”).

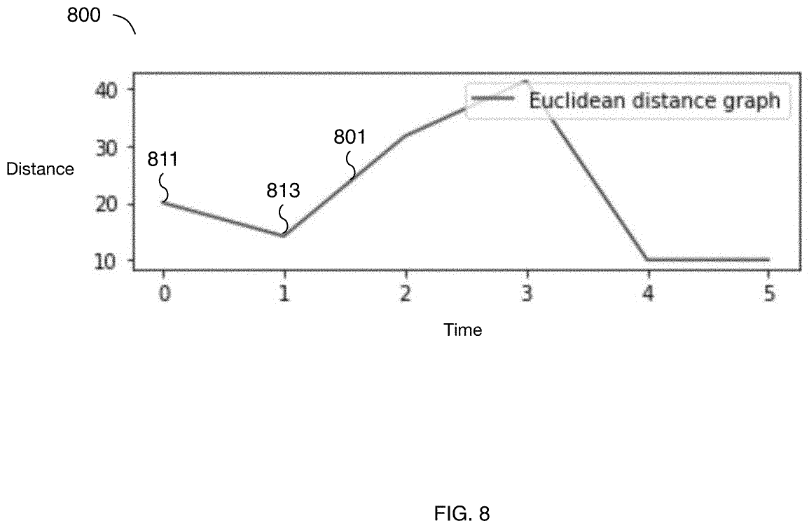

At 703, an ordered series is created using the evaluation results. For example, using the evaluation results from 701, an ordered series is created for pattern analysis. For example, an ordered series of Euclidean distances is created for the password in the same order that the characters of the password are entered. For example, using the example password “TEST123” of 701, the ordered series of character distances is [(20.0), (14.1), (31.6), (41.2), (10.0), (10.0)]. In some embodiments, the created ordered series is presented as a time series and/or as a graph of the ordered series or time series. The graphs of FIGS. 8, 9B, and 10B are examples of created ordered series using character distances presented as distance graphs.

At 705, the created ordered series is analyzed for patterns. For example, the ordered series created at 703 can be analyzed to detect patterns associated with weak passwords. When using an ordered series of character distances, the analysis detects location patterns based on the relative location of the input keys of the key input device. In various embodiments, the analysis techniques can utilize different pattern detection techniques and/or different presentations of the ordered series such as a time series or a graph of the ordered series or time series. In some embodiments, the pattern analysis utilizes statistical analysis, image processing, and/or other appropriate techniques. For example, a statistical model can be created from the ordered series to detect patterns. As another example, a rolling mean and/or standard deviation can be calculated using the values of the ordered series to determine whether the password is random. A rolling mean and/or standard deviation that does not fluctuate much or is close to constant can indicate a weak password. In some embodiments, a graph of the ordered series is segmented into smaller and/or larger windows which are evaluated to detect repeated patterns. In some embodiments, a graph of the ordered series can be evaluated to determine whether the created series is a stationary time series. For example, a Dickey-Fuller, Augmented Dickey-Fuller, or another appropriate test can be applied to a graph of the ordered series to determine if the time series is stationary and is defined by a trend. The existence of a trend can reveal the presence of repeated patterns and can detect the strength of the password based on randomness. In some embodiments, the pattern analysis utilizes a machine learning approach to detect the use of repeated patterns in the graph. In various embodiments, image processing is used, at least in part, for pattern detection. For example, image processing techniques can be applied to the ordered series created at 703 to identify patterns within the provided password. The applied image processing techniques can identify patterns or regularities in the ordered series. In some embodiments, image processing techniques can further be applied to preprocess an image of the created ordered series for analysis. For example, a graph of the created ordered series can be preprocessed to more easily detect patterns.

In various embodiments, the analysis of FIG. 7 is converted into a password strength. For example, in the event a pattern that corresponds to a weak password is detected, the resulting password strength is low. In contrast, in the event a pattern that corresponds to a weak password is not detected, the resulting password strength is high. In various embodiments, the resulting password strength is only valid in the context of the analysis that the password is evaluated for. For example, analyzing the character distance of the password characters can determine whether a password is a weak password based on corresponding input key locations. However, the result does not necessarily reflect that the password is not a weak password due to other properties, such as membership in a dictionary of weak passwords that can include compromised passwords, common words, trivial variations of common words, etc.

FIG. 8 is a diagram illustrating a graph of an ordered series of character distances generated for an example password using location coordinates. In the example shown, location pattern 800 corresponds to the password “TEST123” and the ordered series of character distances [(20.0), (14.1), (31.6), (41.2), (10.0), (10.0)]. The ordered series corresponds to the evaluated Euclidean distances between the characters of the password. The distances are 20.0 between “T” and “E,” 14.1 between “E” and “S,” 31.6 between “S” and “T,” 41.2 between “T” and “1,” 10.0 between “1” and “2,” and 10.0 between “2” and 3.” In the example shown, the distance is shown on the vertical axis and time is shown on the horizontal axis. Location pattern 800 includes distance graph 801. Distance graph 801 has six points, each corresponding to a distance measurement between two neighboring password characters (with the first two points labeled). Distance points 811 and 813 are labelled and correspond to the distance values 20.0 (the distance between “T” and “E”) and 14.1 (the distance between “E” and “S”). In various embodiments, the graph of FIG. 8 is created at 703 of FIG. 7 and analyzed at 705 of FIG. 7 to determine a password strength.

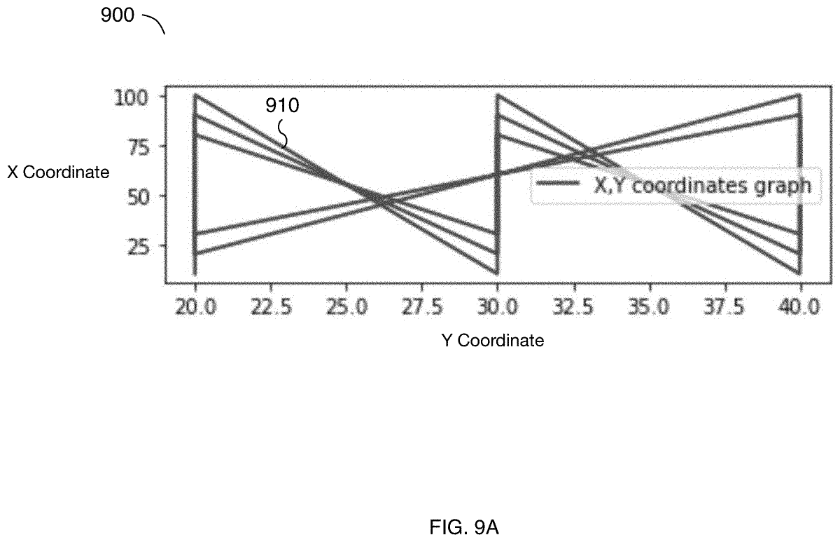

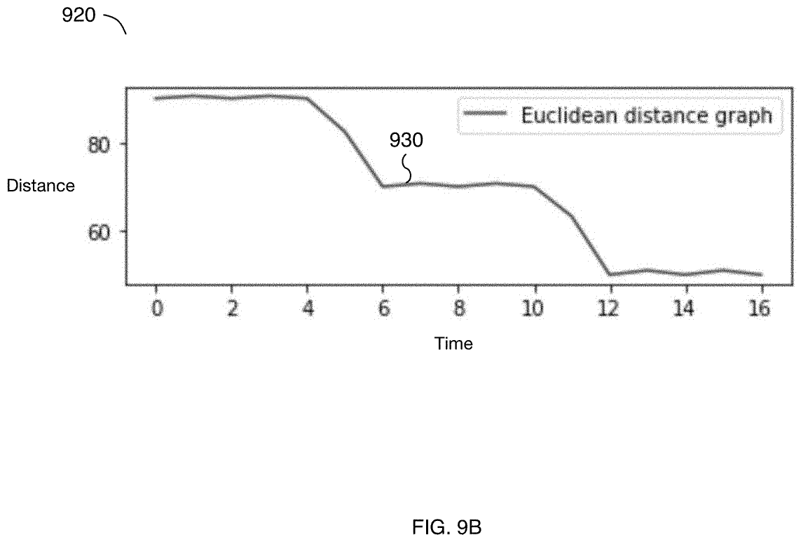

FIG. 9A is a diagram illustrating a graph of an ordered series generated for an example password using location coordinates. In the example shown, location pattern 900 corresponds to the password “QPA;Z/WOSLX.EIDKC,” and the displayed coordinates graph 910 is a graph of the ordered series of (X, Y) coordinates created using the input device key layout of FIG. 3. The password “QPA;Z/WOSLX.EIDKC,” follows a repeated key input pattern with three repeated groups of characters that alternate between the left and right side of the key input device. The three groups are “QPA;Z/” (group 1), “WOSLX.” (group 2), and “EIDKC,” (group 3). In the example shown, the X coordinate is shown on the vertical axis and the Y coordinate is shown on the horizontal axis. In various embodiments, coordinates graph 910 appears, based at least on casual visual inspection, to exhibit a repeated pattern. In various embodiments, additional analysis using the process of FIG. 7 allows the repeated pattern of coordinates graph 910 to be easily detected and to determine that the corresponding password should most likely be treated as a weak password. In some embodiments, the ordered series of coordinates graph 910 is generated at 105 of FIG. 1, 403 of FIG. 4, and/or 503 of FIG. 5.

FIG. 9B is a diagram illustrating a graph of an ordered series of character distances generated for an example password using location coordinates. In the example shown, location pattern 920 corresponds to the password “QPA;Z/WOSLX.EIDKC,” of FIG. 9A and the displayed distance graph 930 is generated using the location coordinates associated with coordinates graph 910 of FIG. 9A. Displayed distance graph 930 is an ordered series of evaluated Euclidean distances between neighboring password characters and exhibits a pattern repeated three times, one corresponding to each group: “QPA;Z/” (group 1), “WOSLX.” (group 2), and “EIDKC,” (group 3). In the example shown, the distance is shown on the vertical axis and time is shown on the horizontal axis. Distance graph 930 has seventeen points, each corresponding to a distance measurement between two neighboring password characters. In various embodiments, the graph of FIG. 9B is created at 703 of FIG. 7 and analyzed at 705 of FIG. 7 to detect a repeated pattern and to determine a password strength. By identifying the repeated pattern in distance graph 930, the password “QPA;Z/WOSLX.EIDKC,” can be evaluated as having a weak password strength.

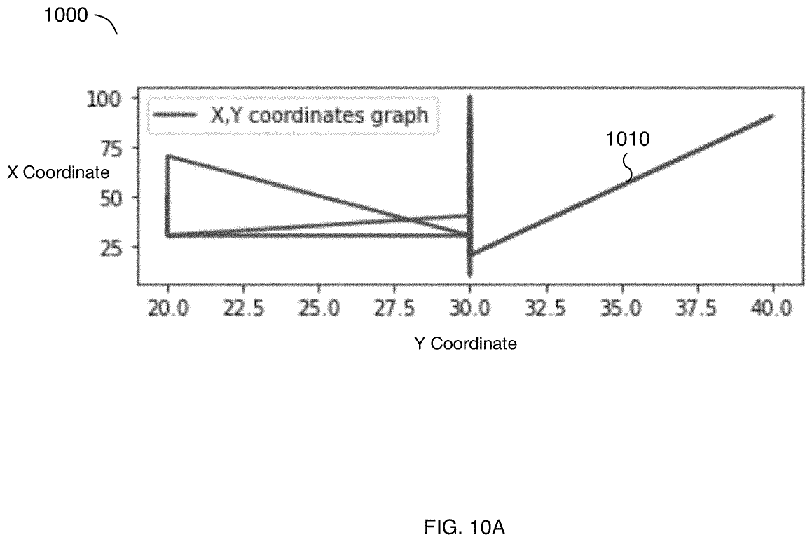

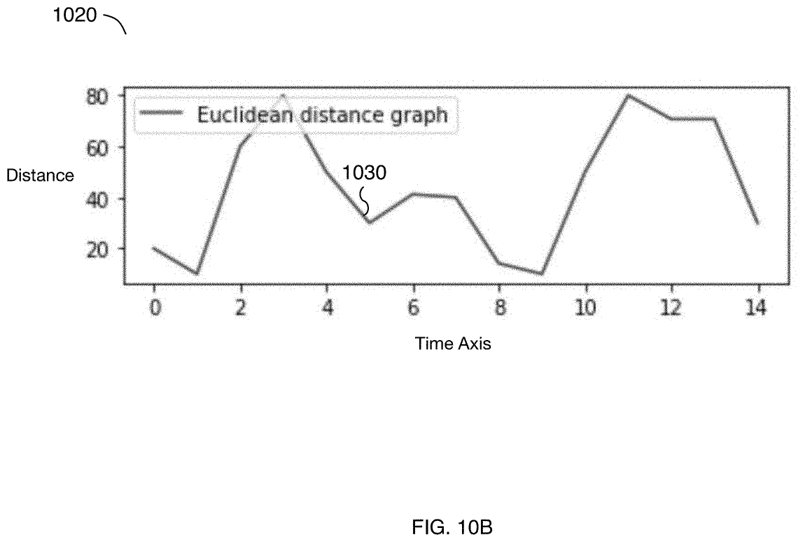

FIG. 10A is a diagram illustrating a graph of an ordered series generated for an example password using location coordinates. In the example shown, location pattern 1000 corresponds to the password “TEDLAHDUEFG;S.SG” and the displayed coordinates graph 1010 is a graph of the ordered series of (X, Y) coordinates created using the input device key layout of FIG. 3. Unlike the password of FIGS. 9A and 9B, the password “TEDLAHDUEFG;S.SG” is a random password and does not follow a repeated key input pattern. In the example shown, the X coordinate is shown on the vertical axis and the Y coordinate is shown on the horizontal axis. In various embodiments, based at least on casual visual inspection, coordinates graph 1010 does not appear to exhibit a repeated pattern. In various embodiments, additional analysis using the process of FIG. 7 further confirms that coordinates graph 1010 does not have a repeated pattern and that the corresponding password should most likely be treated as a strong password. In some embodiments, the ordered series of coordinates graph 1010 is generated at 105 of FIG. 1, 403 of FIG. 4, and/or 503 of FIG. 5.

FIG. 10B is a diagram illustrating a graph of an ordered series of character distances generated for an example password using location coordinates. In the example shown, location pattern 1020 corresponds to the password “TEDLAHDUEFG;S.SG” of FIG. 10A and the displayed distance graph 1030 is generated using the location coordinates associated with coordinates graph 1010 of FIG. 10A. Displayed distance graph 1030 is an ordered series of evaluated Euclidean distances between neighboring password characters and does not exhibit a repeated pattern. In the example shown, the distance is shown on the vertical axis and time is shown on the horizontal axis. Distance graph 1030 has fifteen points, each corresponding to a distance measurement between two neighboring password characters. In various embodiments, the graph of FIG. 10B is created at 703 of FIG. 7 and analyzed at 705 of FIG. 7 to determine that no repeated pattern is detected and to determine a password strength. By confirming that no repeated pattern is found in distance graph 1030, the password “TEDLAHDUEFG;S.SG” can be evaluated as not following a key input pattern and, in the context of the distance-based pattern analysis, has a strong password strength.

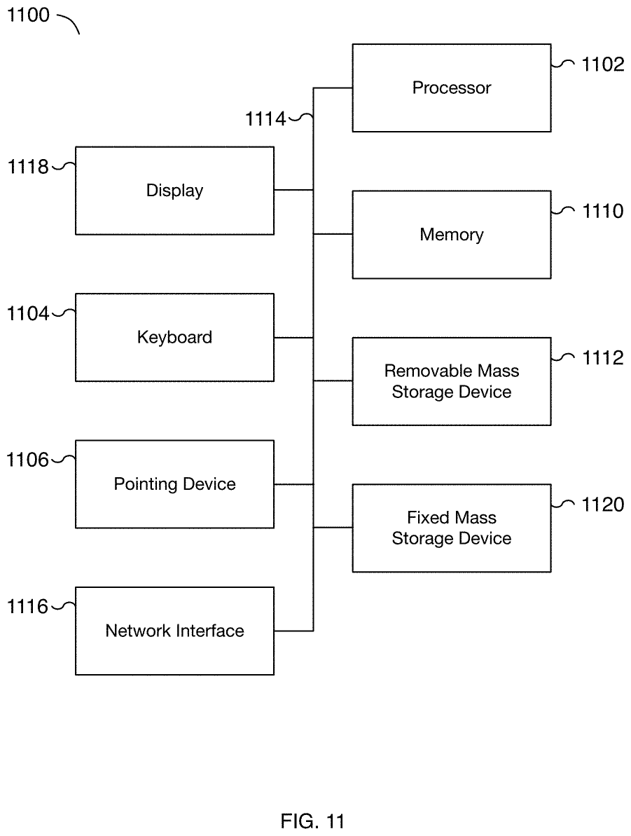

FIG. 11 is a functional diagram illustrating a programmed computer system for detecting password strength using a location pattern analysis. As will be apparent, other computer system architectures and configurations can be used for evaluating password strength using location coordinates and pattern analysis. Examples of computer system 1100 include servers utilized for a password-protected system and/or the servers used by a password-protected system to evaluate password strength. In some embodiments, computer system 1100 is the client device that communicates with a password-protected system. Computer system 1100, which includes various subsystems as described below, includes at least one microprocessor subsystem (also referred to as a processor or a central processing unit (CPU)) 1102. For example, processor 1102 can be implemented by a single-chip processor or by multiple processors. In some embodiments, processor 1102 is a general purpose digital processor that controls the operation of the computer system 1100. Using instructions retrieved from memory 1110, the processor 1102 controls the reception and manipulation of input data, and the output and display of data on output devices (e.g., display 1118). In various embodiments, one or more instances of computer system 1100 can be used to implement at least portions of the processes of FIGS. 1, 2, 4, 5, and/or 7.

Processor 1102 is coupled bi-directionally with memory 1110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also as is well known in the art, primary storage typically includes basic operating instructions, program code, data, and objects used by the processor 1102 to perform its functions (e.g., programmed instructions). For example, memory 1110 can include any suitable computer-readable storage media, described below, depending on whether, for example, data access needs to be bi-directional or unidirectional. For example, processor 1102 can also directly and very rapidly retrieve and store frequently needed data in a cache memory (not shown).

A removable mass storage device 1112 provides additional data storage capacity for the computer system 1100, and is coupled either bi-directionally (read/write) or unidirectionally (read only) to processor 1102. For example, storage 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of mass storage 1120 is a hard disk drive. Mass storages 1112, 1120 generally store additional programming instructions, data, and the like that typically are not in active use by the processor 1102. It will be appreciated that the information retained within mass storages 1112 and 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, the pointing device 1106 can be a mouse, stylus, track ball, or tablet, and is useful for interacting with a graphical user interface.

The network interface 1116 allows processor 1102 to be coupled to another computer, computer network, or telecommunications network using a network connection as shown. For example, through the network interface 1116, the processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow the processor 1102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a password for evaluation;
for each of at least a portion of characters included in the password, determining a corresponding location coordinate of a corresponding physical key location on a physical input device key layout;
using the determined location coordinates, generating an ordered series of data representing the password; and
using one or more processors to determine a strength of the password including by utilizing the generated ordered series of data to perform an analysis based on location pattern detection.

2. The method of claim 1, wherein the determined location coordinates are two-dimensional location coordinates.

3. The method of claim 1, wherein the determined location coordinates are three-dimensional location coordinates.

4. The method of claim 3, wherein a dimension of the three-dimensional location coordinates is based on a modifier key.

5. The method of claim 4, wherein the modifier key is a shift key.

6. The method of claim 1, further comprising:
determining a corresponding key size for each of one or more physical keys associated with the physical input device key layout; and
assigning a location coordinate to each of the one or more physical keys based at least in part on the determined corresponding key size of each corresponding physical key.

7. The method of claim 6, wherein the corresponding key size is one of two or more different key sizes.

8. The method of claim 1, wherein the physical input device key layout corresponds to a key input device, and wherein the key input device includes two or more physically separated key input device components.

9. The method of claim 1, wherein the physical input device key layout corresponds to a layout of a virtual keyboard.

10. The method of claim 1, further comprising:
determining a key input device type associated with the password for evaluation; and
assigning a coordinate system to the physical input device key layout based on the determined key input device type.

11. The method of claim 1, further comprising:
identifying an invalid password character;
determining a physical location associated with the invalid password character on a key input device; and
in response to a determination that the physical location is on a periphery of the key input device, removing a corresponding input key of the invalid password character from the physical input device key layout.

12. The method of claim 11, wherein the removed input key is a shift key, a caps lock key, an enter key, a space key, or a delete key.

13. A system, comprising:
one or more processors; and
a memory coupled to the one or more processors, wherein the memory is configured to provide the one or more processors with instructions which when executed cause the one or more processors to:
receive a password for evaluation;
for each of at least a portion of characters included in the password, determine a corresponding location coordinate of a corresponding physical key location on a physical input device key layout;
use the determined location coordinates to generate an ordered series of data representing the password; and
determine a strength of the password including by utilizing the generated ordered series of data to perform an analysis based on location pattern detection.

14. The system of claim 13, wherein the determined location coordinates are two-dimensional location coordinates.

15. The system of claim 13, wherein the memory is further configured to provide the one or more processors with the instructions which when executed cause the one or more processors to:
determine a corresponding key size for each of one or more physical keys associated with the physical input device key layout; and
assign a location coordinate to each of the one or more physical keys based at least in part on the determined corresponding key size of each corresponding physical key.

16. The system of claim 13, wherein the physical input device key layout corresponds to a key input device, and wherein the key input device includes two or more physically separated key input device components.

17. The system of claim 13, wherein the physical input device key layout corresponds to a layout of a virtual keyboard.

18. The system of claim 13, wherein the memory is further configured to provide the one or more processors with the instructions which when executed cause the one or more processors to:
determine a key input device type associated with the password for evaluation; and
assign a coordinate system to the physical input device key layout based on the determined key input device type.

19. The system of claim 13, wherein the memory is further configured to provide the one or more processors with the instructions which when executed cause the one or more processors to:
identify an invalid password character;
determine a physical location associated with the invalid password character on a key input device; and
in response to a determination that the physical location is on a periphery of the key input device, remove a corresponding input key of the invalid password character from the physical input device key layout.

20. A computer program product, the computer program product being embodied in a non-transitory computer readable storage medium and comprising computer instructions for:
receiving a password for evaluation;
for each of at least a portion of characters included in the password, determining a corresponding location coordinate of a corresponding physical key location on a physical input device key layout;
using the determined location coordinates, generating an ordered series of data representing the password; and
determining a strength of the password including by utilizing the generated ordered series of data to perform an analysis based on location pattern detection.
